(19) United States
(12) Patent Application Publication
(10) Pub. No.: US 2010/0201831 A1
(43) Pub. Date: Aug. 12, 2010

(54) DIGITAL CAMERA WITH ASYMMETRICALLY CONFIGURED SENSORS

(76) Inventor: Larry R. Weinstein, Tallahassee, FL (US)

Correspondence Address: Larry R. Weinstein, 5040 Barfield Rd., Tallahassee, FL, 32308, US

(21) Appl. No.: 12/368,326

(22) Filed: Feb. 10, 2009

(51) Int. Cl. H04N 5/235; H04N 5/225

(52) U.S. Cl. 348/221.1; 348/360; 348/E05.034; 348/E05.024

(57) ABSTRACT

A method is described by which two, asymmetrically configured sensors, one being panchromatic and the other recording color, may be employed in a digital camera so as to exceed the performance, in terms of signal-to-noise ratio, resolution, and dynamic range, and with regard to visual perception, of a single sensor of the same approximate size.

### FIELD OF THE INVENTION

This invention relates to an improved form of digital camera that can be used for still image and video capture.

### BACKGROUND OF THE INVENTION

The design of a sensor system for a digital camera involves multiple tradeoffs. These include factors affecting the final image quality such as dynamic range, responsiveness in low light environments, resolution, signal-to-noise ratio, and freedom from digital artifacts. They also involve weight and cost, both of the sensor and the overall camera system. These tradeoffs must take into account the changing role of the digital camera. The differentiation between still image and video cameras has largely disappeared. Increasingly, cameras are required to do well in both roles. It is also true that one of the most common types of cameras, the single lens reflex, may soon be eclipsed by cameras that possess electronic viewfinders and real time visual displays of through-the-lens camera views.

The modern digital camera sensor consists of an array of photoreceptors each of which will convert an entering photon into a measure of electrical charge. The electrical charges that are built up during the exposure time are held until a readout operation is performed. This readout process performs analog operations upon the signal and then converts it into a digital value. These readout and conversion processes have an associated noise factor that cause the final digital value to be other than a perfect representation of the number of photons entering the photoreceptor.

Each photoreceptor can hold only a limited number of electrical charges. The number of charges that can be held is proportional to the area covered by the photoreceptor. If more charges arrive after the maximum number is stored, the photoreceptor overflows. Therefore, the information contained in those photons arriving after the maximum number is reached is lost.

Color filters are placed in front of each photoreceptor. The most common pattern used is known as the Bayer pattern, after the inventor (U.S. Pat. No. 3,971,065). The color filters, which are red, green and blue in the Bayer pattern, only permit photons within a certain range of frequencies to pass through to the matching photoreceptors. To construct a full color pixel, it is necessary to combine, in the mathematical sense, the information derived from at least one red, one green, and one blue photoreceptor.

In addition to the readout noise discussed above, there is another source of noise associated with the photoreceptors. The gathering of photons is a sampling process that follows Poisson statistics. In accordance with these statistics, noise will be proportional to the inverse of the square root of the number of photons sampled. When the number of photons is high (in the thousands and tens of thousands), this noise factor is very much smaller than the readout noise. However, at low numbers of photons, this noise factor can be significant. Even under conditions that offer a large amount of light, some parts of an image will be “dark,” implying that fewer photons will strike the corresponding photoreceptors. In conditions of low light, noise can become a significant factor in the quality of the output of the photoreceptors. Since the number of photons entering each photoreceptor is proportional to the total amount of light striking the sensor divided by the number of photoreceptors (assuming that all are of equal size), increasing the number of photoreceptors on a sensor will result in greater noise under given lighting conditions. The signal-to-noise ratio is a mathematical comparison, by simple division and sometimes expressed logarithmically, of the total noise and the true signal. The design of a camera sensor attempts to maximize the signal-to-noise ratio.

The dynamic range of a sensor measures the difference between the least number of photons that a photoreceptor can record with a given level of accuracy and the highest number it can record. The low number is restricted by the noise sources. The high number is limited by the number of electrical charges that can be held and hence the area of the photoreceptor. When the dynamic range is small, the camera will not be able to faithfully capture images of scenes that have large variations in light. To see this effect, consider a conventional Bayer sensor camera that is attempting to record, in part, the image of a bright, blue sky. Since most of the color is blue, the blue filtered sensor will become filled first as the number of incoming photons rises. The red and green photoreceptors will be able to record increasing numbers of photons, but there will be no proportional increase at the blue sensors. As a consequence, the recorded color will become less saturated (more white). At some point, all of the photoreceptors will reach saturation and the color will be recorded as equal and maximum amounts of red, green, and blue−a white color. This is a phenomenon that is familiar to anyone who has take snapshots of people on a sunny day.

The resolution of a sensor is the amount of detail it can detect. There can be a difference in monochromatic resolution and in color resolution in the same sensor. In fact, sensors with Bayer patterns have higher resolutions in green colors than in red or blue colors. The more densely packed the photoreceptors are on a sensor, the higher will resolution it will have. However, the detail captured by a more densely packed sensor can be obscured by noise and limited by low dynamic range.

As has been discussed, for a given sized sensor, larger photoreceptors will have better signal-to-noise ratios and a greater dynamic ranges. Smaller photoreceptors will have higher resolution, but more noise.

The cost of a solid-state camera sensor goes up exponentially with its size. Within the camera system, the size of the sensor determines the size of other components, such as lenses, that also rise at a faster than linear rate. The size and weight of the camera system is dependent upon the size of the sensor. Therefore, there is some motivation to use small sensors in cameras. Larger sensors, that permit either more photoreceptors or larger photoreceptors or both, provided they have the proper supporting components, have advantages in that they produce images of superior quality, especially under conditions that limit the available light.

These tradeoffs dominate the design factors for digital camera sensors. Improving one factor at the cost of another may result in a degradation of the image quality. The discussion to follow concerns an invention that makes use of two sensors in a single digital camera. This is not the first time it has been suggested that two sensors, or even two sensors recording color and panchromatic data respectively, might be used in some type (video) of camera. However, previous designs have not been targeted for use in cameras intended both for high quality still image capture and also high quality video capture. These earlier designs were dedicated to issues other than the ones addressed here, always making them unsuitable for use in a still image camera. The current invention takes into account the tradeoffs discussed above, as well as the current role of the digital camera, so as to produce a device with superior image quality output and enhanced functionality.

Light entering a camera carries with it two forms of information. First, the distribution of the flow of photons, or flux, over the two-dimensional focal plane carries luminance information. Second, the distribution of photon energies, as determined by their frequencies, or color, carries chrominance information. A sensor's photoreceptors sample the flux, typically in a regular pattern of rows and columns. If color filters are placed over the photoreceptors, then each samples only the flux within a color band. Because each filter rejects approximately two thirds of the photons arriving at a photo-site, approximately two thirds of the information available is lost. On the other hand, when an unfiltered photoreceptor detects a photon, the color information is lost.

There are ways of dividing light, using some form of refractive device (e.g. prism), into selected ranges of colors and directing such light to sensors. A system in which the light is divided twice and routed to three sensors is commonly found in video cameras. The physical size of the color separating mechanism is such that constraints are placed on the system with regard to the lens devices that can be used and the size of the sensors. Such devices will not be considered here.

Examples of cameras employing one sensor with a combination of panchromatic (unfiltered) photoreceptors and color filtered receptors, or two-sensors, one with panchromatic (unfiltered) receptors and the other with color-filtered receptors can be found in the literature. All such examples result in cameras that produce images that are inferior to those produced by cameras with conventional sensors.

A photoreceptor with a filter over it will hold just as much charge as a photoreceptor without a filter. If non-filtered photoreceptors and filtered photoreceptors of the same size are used in the same sensor, then, since the unfiltered photoreceptors accept three times as many photons on average, they will reach maximum charge three times faster. As soon as this point is past, their information becomes invalid.

If the camera system takes care to limit the exposure such that the non-filtered photoreceptors do not reach their maximum storage capacity, then the color-filtered sensors will each only hold one third of the charge they would otherwise receive. With their signal output reduced, the signal-to-noise ratio is reduced. A possible solution in a two-sensor system might be to allocate one fourth of the light to the panchromatic sensor and the remaining three fourths of the light to the color-filtered sensor. In this case, the luminance data and chrominance data are each less accurate than the data gathered by a conventional sensor, since they are each based on fewer photons than in the conventional system. That is, they have a reduced signal-to-noise ratio.

There is no obvious way out of this design dilemma. These designs either reduce the signal-to-noise ratio, they reduce the dynamic range, or they do both. This is the problem that is addressed by the current invention.

### Definitions

Digital Camera: a camera using solid-state sensors rather than film.
Camera Sensor: a solid-state device that is capable of recording the intensity of visible light at multiple points across a two dimensional surface.
Bayer Pattern: a pattern of red, green, and blue color filters that enables a Camera Sensor to record color images.
Photo-site: the area of a single light detector on a Camera Sensor.
Photoreceptor: a light detector on a Camera Sensor.
Flux: the amount of light, in photons per unit area per unit time.
Foveon: a type of Camera Sensor where three photoreceptors are stacked in each photo-site.
The medium of the Camera Sensor (silicon) acts as a color filter, so that each photoreceptor records light of a different frequency band.
Stop: this is a photographic term that refers to a halving or doubling of light.
Asymmetrical: not having similarity in size, shape, or relative position of corresponding parts

### SUMMARY OF THE INVENTION

The invention encompasses a method by which two, asymmetrically configured sensors in a camera may be employed so as to exceed the performance of a single sensor of the same approximate size. The metric of performance is to be a measure of image quality, specifically addressing the issues of noise, resolution, and dynamic range. The primary support systems, especially the lens system, required for the dual sensor instantiation, are no different from those that would be used for one of the sensors alone, hence it is far less costly and more compact than a system that is based upon a larger sensor.

The dual, asymmetrically configured sensors system is described as follows. In the system there is one color-filtered sensor and one panchromatic sensor. A partially silvered mirror or other mechanism divides the light delivered by the lens system so that some falls on each sensor, though the proportions are not necessarily equal. The design of the dividing mechanism is such that it minimizes loss of light, any division based upon frequency of the light, and any optical distortion. The sensors produce image information that is later combined in a particular manner so as to produce one image. The mirror or other dividing device may be fixed or moveable. A moveable device will allow all of the light to strike just one of the two sensors when this is advantageous to the functioning of the camera. The configuration, number, and size of the photoreceptors on each sensor, along with the proportion of the light distribution, are variables of the design process. These variables are constrained by rules that are the subject of the current invention, with the intended purpose of improving the image quality according to some metric that includes the factors of signal-to-noise ratio, resolution, and dynamic range. The rules will be presented here. Their rationale, derivation, and application are presented in the Detailed Description.

### Where:

SA is the area of each of the single sensor's photo-sites;
MA is the area of each of the panchromatic sensor's photo-sites;
CA is the area of each of the dual sensor color-filtered sensor's photo-sites;
SP is the number of photons arriving at each of the single sensor's photo-sites;
MP is the number of photons arriving at each of the panchromatic sensor's photo-sites;
CP is the number of photons arriving at each of the dual sensor color-filtered sensor's photo-sites; and
E is the relative efficiency at recording photons of the panchromatic sensor as compared to the color-filtered sensor.
ML is the fraction of light directed at the panchromatic sensor.
SA and SP are set to values of unity (1.0) for purposes of comparison.
The following design rules are to apply.

CA>1/(1−ML)

MA<=1

ML>=1/E*MA

ML<(CA−1)/CA

ML<CA/(E+CA)

There are additional rules that are based on visual perception.

CA/MA<=9 yields excellent image results,

9<CA/MA<=12 yields good image results, and

12<CA/MA<25 yields acceptable image results

In order to make use of two sensors, it is necessary to combine their outputs. A two dimensional array of values is established from the panchromatic sensor. This array is a one-to-one mapping of its output values. Therefore, the array will have the same dimensions as the photoreceptors on the panchromatic sensor. For each data point in the two dimensional array, a corresponding dataset, consisting of a color triplet (red, green, and blue values) is determined, based on data from the color-filtered sensor. Finally, the data point from the panchromatic sensor's array is combined with the color triplet derived from the color-filtered sensor to produce a color triplet output. The final result is a two dimensional array of triplet values with the same dimensions as the panchromatic sensor.

The current invention takes advantage of elements of human visual perception. The perception of image quality is more sensitive to luminance resolution than color resolution. In the darkest areas of an image, extended dynamic range and reduced noise are more important than resolution. In dark areas of an image, color noise is more objectionable than luminance noise. Increased dynamic range and reduced noise will permit the operation of a camera in reduced levels of light.

With these factors in mind, the trade-off being made when using the current invention as compared to a conventional single sensor camera is as follows. Color resolution is reduced, but luminance resolution is enhanced throughout most of the image. The exception is only for the darkest image pixels (typically in the lowest one stop) where the general resolution is reduced, but the signal-to-noise ratio is increased. Noise is reduced throughout the image. The dynamic range is extended (typically by more than two stops.).

The improvement to resolution is greater than it might first appear. A panchromatic sensor with a given number of photoreceptors will exhibit greater resolution than that of a color-filtered sensor with the same number of photoreceptors, in the general case. The rule-of-thumb is that the apparent resolution of a panchromatic sensor will be equal to a color-filtered sensor with one and one-half times as many photoreceptors.

This trade-off is possible due to the use of dissimilar sensors whose photoreceptors differ in size, configuration, and count. By designing the system so that the photoreceptors on the color sensor are significantly larger than those on the panchromatic sensor, the luminance resolution is de-coupled from the color resolution. This, in turn, permits the allocation of light by the splitting element to be designed so as to insure than noise is not increased for either the panchromatic photoreceptors or the color-filtered photoreceptors. The smaller panchromatic photoreceptors insure that the system has a higher resolution than the conventional system throughout almost the entire image, regardless of content (without having higher noise, as just explained.) The larger color-filtered sensors yield a greater system dynamic range.

### THE DRAWINGS

FIG. 1 This figure shows the basic configuration of a single sensor camera. Light enters through a lens system [4] and strikes the color-filtered sensor [5].

FIG. 2 This figure shows the basic configuration of a dual sensor camera. Light enters through a lens system [4]. Some of the light passes through the partially silvered mirror [1] and strikes the color-filtered sensor [2]. The remainder of the light is reflected onto the panchromatic sensor [3].

FIG. 3 FIG. 3a depicts the relative size of photo-sites on the color-filtered sensor [5] of a single sensor camera. FIG. 3b depicts the relative size of the photo-sites on the panchromatic sensor [3] of a dual sensor camera. FIG. 3c depicts the relative size of the photo-sites on the color-filtered sensor [2] of a dual sensor camera.

FIG. 4 This figure shows the basic configuration of a dual sensor camera with a moved mirror [1].

### DETAILED DESCRIPTION

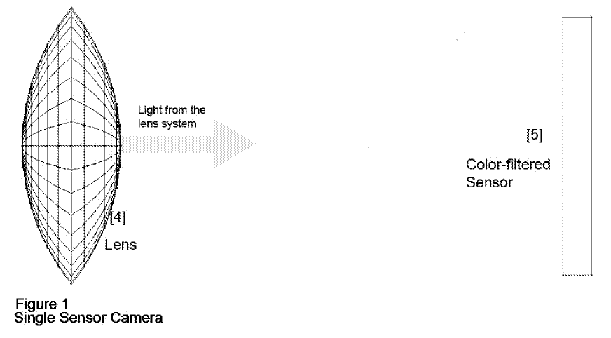

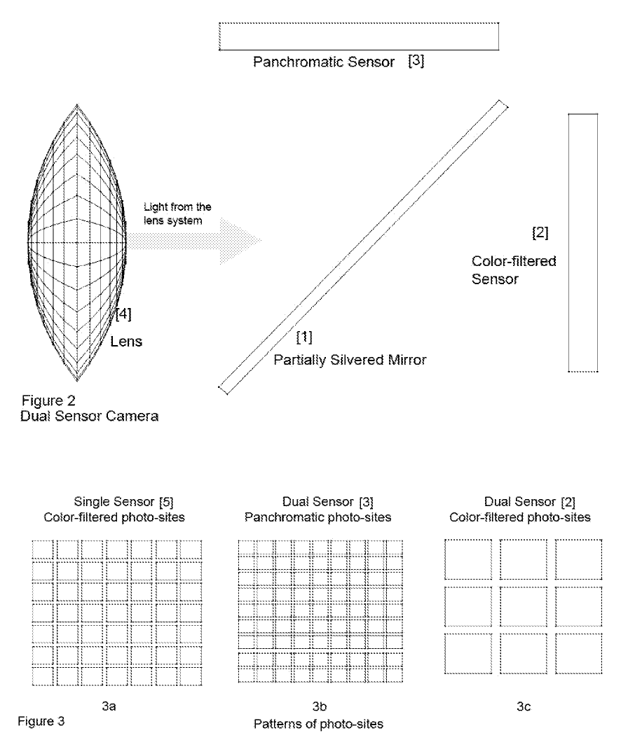

FIG. 1 shows the most basic elements of a camera based upon a single sensor [5] with a Bayer pattern of color-filtered photoreceptors. Assume for the purpose of this discussion that the physical size of the photo-sites on this sensor is such that the photon gathering ability of the photoreceptors meets some minimum criterion for signal-to-noise ratio. FIG. 2 shows the most basic elements of a camera based upon the current invention. In FIG. 2 incoming light from a lens system [4] is intercepted by partially silvered mirror [1]. Some of the light passes through the mirror and lands upon color-filtered sensor [2]. The remainder of the light is reflected onto panchromatic sensor [3].

FIG. 3a shows part of the pattern of color-filtered photo-sites from sensor [5], the sensor of a single sensor camera. FIG. 3b shows part of the pattern of panchromatic photo-sites of sensor [3]. FIG. 3c shows part of the pattern of color-filtered sensor [2]. The patterns of this figure are drawn to scale. The proportions match the design example (1) of the preferred embodiment given below.

There are three important aspects to consider at this point. First, all three of the sensors ([2], [3], and [5]) are the same size or nearly so. Second, the sizes of the photo-sites differ, as do the configuration of the photo-sites, and as do the count of the photo-sites on each sensor respectively. Third, the sizes, configurations, and counts are related, that these relationships are an integral component of the current invention, as is the proportion of light directed at each sensor, and that they are designed so that a camera based on the two, asymmetrically configured sensors of the current invention will produce an image with characteristics that are superior to one produced on a camera based on a conventional single sensor when factors of visual perception are considered.

The objectives of any design based on the current invention are as follows. The signal-to-noise ratio of an image should be improved. Dynamic range should be increased. The apparent resolution should be increased. The term “apparent” is used because the luminance resolution will be increased throughout most, but not all of the image, while the chrominance resolution will be decreased.

Assume the following definitions:
SA is the area of each of the single sensor's photo-sites;
MA is the area of each of the panchromatic sensor's photo-sites;
CA is the area of each of the dual sensor color-filtered sensor's photo-sites;
SP is the number of photons arriving at each of the single sensor's photo-sites;
MP is the number of photons arriving at each of the panchromatic sensor's photo-sites;
CP is the number of photons arriving at each of the dual sensor color-filtered sensor's photo-sites; and
E is the relative efficiency at recording photons of the panchromatic sensor as compared to the color-filtered sensor.
ML is the fraction of light directed at the panchromatic sensor.

The signal-to-noise requirement gives us:

CP>=MP*E>SP

The panchromatic sensor will record, on average, more photons than the color-filtered sensors. For the purposes of the calculations presented here, the panchromatic sensors are assumed to record three to four times as many photons, on average, as the color-filtered sensors. In order that the signal-to-noise ratio be maintained or improved, the photon counts must be equal or greater than in a conventional system. If either the panchromatic sensor's photoreceptors or the color-filtered sensor's photoreceptors receive fewer photons than the conventional sensor's photoreceptors, noise will be increased. Since the luminance values of the output will be taken from color-filtered sensor, if necessary, in the darker parts of the image, a possible substitute rule, with diminished output image quality, is:

CP>=MP*E*2>SP (deprecated)

Since the area of each photo-site and the division of light determine the number of photons received at each photo-site, we now have:

ML*MA*E=MP*E>SP

(1−ML)*CA=CP>SP

Since we desire to increase the resolution of (at least) the luminance sensor:

MA<=SA

Using values of 1.0 for SA and SP, we have:

MA<=1.0

ML>=1/E*MA

CA>1.0/(1−ML)

CP>=MP*E, therefore:

(1−ML)*CA>=ML*E*MA;

CA−ML*CA>=ML*E*MA;

CA>=ML*E*MA+ML*CA;

CA>=ML*(E*MA+CA);

CA/(E*MA+CA)>=ML; and

ML=<CA/(E*MA+CA).

These values insure that the number of photons gathered by each photoreceptor on the dual sensors is greater than the number of photons gathered by each photoreceptor on the single sensor. Thus, the signal-to-noise ratio is improved.

There is another factor that must be considered. This factor deals with dynamic range. Since the panchromatic photoreceptors may be smaller than the color-filtered photoreceptors of the single sensor solution, they may also have a reduced dynamic range. The intent is to use the output of the color-filtered sensors of the two sensors solution in the darker areas of the image, where the loss of resolution will not be apparent. In order to avoid saturating the panchromatic photoreceptors, it will necessary that the exposure time will be reduced. Therefore, fewer photons will be recorded. In photographic terms, this is an “ISO” measure. In order to insure that the noise levels in the color-filtered photoreceptors of the dual sensor system do not become excessive, we must insure a more stringent condition than the one given above (CP>=SP). The condition is as follows.

CP>(MP/MA)(SP/SA), therefore:

CP>(MP/MA)

CP>E*ML

CA*(131 ML)>E*ML

CA−CA*ML>E*ML

CA−CA*ML−E*ML>0

CA−ML*(CA+E)>0

CA>ML*(CA+E)

ML<CA/(CA+E)

The rules are now these.

CA>1/(1−ML)

MA<=1

ML>=1/E*MA

ML<(CA−1)/CA

ML<CA/(E+CA)

There are additional rules that are based on visual perception.

CA/MA<=9 yields excellent results,

9<CA/MA<=12 yields good results, and

12<CA/MA<25 yields acceptable results

The use of two sensors includes the requirement that the data from the two sensors be combined. This involves issues of correspondence, registration, and substitution.

The color-filtered sensor has a different configuration of photoreceptors than does the luminance sensor. In addition, the color-filtered sensor has three subsets of photoreceptors that are not typically co-located. There are non-Bayer types of color sensitive sensors, such as the Foveon, that are co-located. These work equally well with the current invention. They would merely simplify the correspondence procedure.

An alignment procedure is performed, perhaps only once when the camera is manufactured, that establishes the physical relationship between the rows and columns of photo-sites on the two sensors. When the camera views a common grayscale target, landmarks can be located in the output of each sensor. To simplify the next discussion, assume that during the alignment procedure, the target is translated and rotated until it aligns perfectly with the photoreceptors of the panchromatic sensor. The camera itself could also be translated and rotated. The landmarks will identify the corner photoreceptors, the two-dimensional scaling, offset, and the rotational angle between the two arrays. Since this invention anticipates that the photo-sites on the color-filtered sensor will be larger than those on the panchromatic sensor, the alignment has a relaxed requirement for accuracy.

The color-filtered sensor's data is gathered and formed into three arrays of single values, one array per color. For each photoreceptor on the panchromatic sensor, a location on a theoretical rectangle is computed. This location is a set of two-dimensional co-ordinates (horizontal and vertical), each with values from 0 to 1. The co-ordinates are derived from the relative position of the photoreceptors in the physical array relative to the corner positions established in the alignment procedure. The co-ordinates identify a position on the theoretical rectangle that is associated with the color-filtered sensor. The rotation, translation, and scaling operations are then performed based on the alignment data. The results are three co-ordinate sets. These co-ordinate sets will indicate which values within the respective three, color sensor's data arrays, will be used to establish the corresponding color values. The co-ordinate sets will also supply the two dimensional interpolation variables. An interpolation is performed within each color array. In the preferred embodiment, this will be a bi-linear or bi-cubic interpolation, though other methods may be used. The results are formed in a triplet of {r′, g′, b′} values that are matched to the single luminance value (lp).

The data points from the panchromatic sensor and the triplets from the color-filtered sensor are combined in accordance with the following formula.

lp=panchromatic sensor's uncorrected*pixel value

P is the correction*factor for the panchromatic sensor to the r,g,b model

Ic=panchromatic sensor's corrected pixel value

{r′, g′, b′} is the color-filtered sensor's pixel value

{r, g, b} is the color-filtered sensor's pixel value (red, green, and blue) corrected to the r, g, b model

C(r′, g′, b′}={r, g, b} is the sensor adjustment function

HSL(r, g, b)={h, s, lm} is the function that derives hue, saturation, and luminance values from the {r, g, b} values.

HSL′(h, s, lm)={r, g, b} is the inverse function that derives r, g, b values from hue, saturation, and luminance values.

*The responses to light for each sensor may not match the ideal luminance and {r,g,b} values. They must be corrected. For the luminance value, this is typically a scaling. For the {r,g,b} values, this is a matrix multiply operation.
Let K be some photon count such that a minimum level of signal-to-noise ratio is met for the photoreceptors in use. Let R be the maximum count of photons the panchromatic sensor can reliably record.

| | |
|---|---|
| lm = P * lp | // convert the panchromatic sensor output |
| {r, g, b} = C(r′, g′, b′} | // convert the color filtered sensor output |
| {h, s, lc} = HSL(r, g, b) | // derive the hue, saturation, and luminance |
| if (lp < K and | // Test raw data against minimum photon |
| (r′+g′+b′) < K) | count |
| {r, g, b} = {0, 0, 0} | // Set to black, counts are below noise floor |
| else if (lp >= K && lp < R) | // Is the panchromatic sensor's output |
| | useable? |
| { | |
| lc = M( )*lm + | // Not by itself, mix with the color sensor |
| (1 − M( ))*lc; | |
| (r, g, b) = HSL′(h, s, lc) | // derive the r, g, b values |
| } | |

The “mixing” function [M( )] yields an output between zero and one (0,1). In its simplest form, it considers only the photon counts of the panchromatic sensor (lp). As these become smaller, reducing the signal-to-noise ratio, the function produces a smaller result. If these reach some maximum, the function produces a zero result. Consequently, a greater percentage of the value derived from the color-filtered sensor is used. A more complex version of the function would consider other factors, such as the local spatial frequency of the image. Noise is more noticeable when the local spatial frequency is low. The lower resolution, but also lower noise output of the color-filtered sensor would be more useful in such a situation.

The output of the entire series of operations is an array of triplets ({r,g,b}) that have the same number of rows and columns as the data from the panchromatic sensor. The hue and saturation values of the triplets came from the data produced by the color-filtered sensor. The luminance data used to produce the triplets came from the panchromatic sensor, the color-filtered sensor, or a combination of the two, depending upon the value of the mixing function.

### Preferred Embodiment Example 1

In this example the configuration of the color sensor is partially determined by the desire to maintain compatibility with High Definition video. High Definition video is recorded in a pixel configuration of one thousand nine hundred and twenty by one thousand and eighty (1920×1080). This places a constraint on the configuration of the color sensor. An additional constraint is the desire to maintain compatibility with the photographic standard of a width to height ratio of four to three. It is therefore decided that the color sensor will have a configuration of one thousand nine hundred and twenty by one thousand four hundred and forty (1920×1440). Video images can be produced by mapping a subset of the color sensor's output using a one-to-one correspondence to the desired video output.

Mindful of these constraints, the following calculations are made.

Color sensor's number of photo-sites=(1920*1440)=2,764,800.

We now must select a conventional single sensor solution for comparison purposes. In this case, we select a single sensor such that:

SA*5=CA

That is there are:

2,764,800*5=13,824,000

photo-sites on the conventional single sensor. This is a reasonable number by the modern standard. The design example will produce a result that provides improved resolution, better signal-to-noise ratio, and better dynamic range, when elements of visual perception are considered.

For this example we select a multiplier of nine (9) between the sizes of the panchromatic photoreceptors and those of the color-filtered sensor, such that

CA=5

MA=CA9=0.56

See FIG. 3 for a relative size comparison. For the purposes of this example, let

E=3

### Therefore:

ML<CA/(3+CA)<5/(3+5)<0.625

ML>=1/(3*MA)>=1/(3*0.56)>=0.595
A value of 0.6 is selected for ML.
   The values of MP and CP are readily determined to be:

MP=(0.6*0.56)=0.336

CP=(1.0−0.6)*5.0=2.0.

These conform to our rules of:

CP>=MP*3>1.0 as 2.0>=1.008>1.0.

The still image output of the camera, based on the panchromatic sensor's dimensions, will be:

5760×4320˜24.88 million pixels.

A camera based on this example will have at least one stop lower apparent noise, approximately one stop greater dynamic range, and approximately thirty-three percent greater linear resolution than a conventional single sensor camera. As mentioned above, the apparent improvement in resolution may be approximately fifty percent. A camera that was based on one sensor that was twice the area of those in this example could not match this performance.

### Preferred Embodiment Example 2

Begin with a 10 “megapixel” (million pixel, and also million photoreceptor), single sensor camera. The camera's sensor is replaced by dual asymmetrically configured sensors, as described by the current invention. Assume the following.
E=4
SA=1
SP=1
   Choose, in accordance with the rules of implementation of the current invention:

MA=1(MA>=1)

CA=8.138(CA/MA<=9)

ML=0.66(0.25<=ML<0.67 and [CP>=MP*3>=1], (2.76>=2.64>1))

The result is that the output of the camera is still 10 million pixels. However, there is some improvement in the resolution due to the effect of using 10 million panchromatic photoreceptors as opposed to 10 million color-filtered photoreceptors. The signal-to-noise ratio is more than doubled (2.66 times), as is the dynamic range. In photographic terms, this camera has a more than one stop advantage over the original camera, with enhanced resolution. Another advantage is that the color-filtered sensor is in a configuration (of 1280×720) that will permit it to generate images and video matching an HDTV standard with a “three stop” advantage (it needs less than one eighth the light to operate).

In this example, had the color-filtered sensor's photo-sites not been enlarged, the loss of light due to the division with panchromatic sensor would have worsened the signal-to-noise ratio of the camera. This would have caused there to be a reduced useable dynamic range.

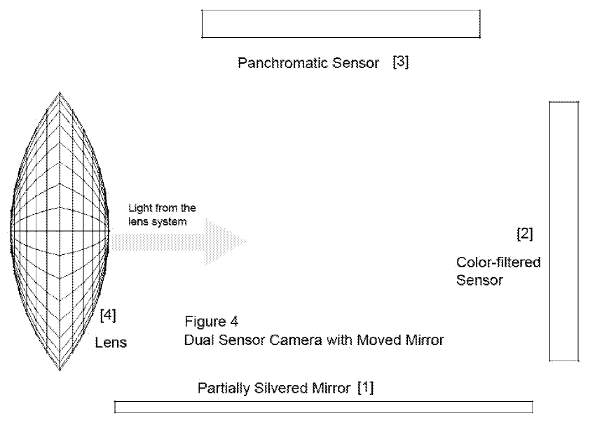

There is an advantage to making the mirror moveable (FIG. 4). That will allow all of the incoming light to fall upon only one of the sensors. Some of the advantages that occur when the color-filtered sensor receives all of the light are discussed below.

The color sensor can be designed so as to be used to generate color video, including high definition video. The large photoreceptors will enable the sensor to be able to work in lower light and have lower noise than is possible in a single sensor camera.

Some photography enthusiasts might appreciate a version of the asymmetrically configured, dual sensors camera where all of the light can be directed at the panchromatic sensor. This would allow the best option for pure, black and white photography while maintaining color capability.

Low light photography, at the resolution of the color-filtered sensor, is an option.

Contrast focusing, which is likely to be used in a camera with dual sensors, will work better in low light situations with the large photoreceptors. If focus cannot be achieved with the mirror in the standard position, a mode could allow focus to be made with the mirror moved. The mirror could be returned to the normal position just prior to the exposure.

The display of the “live view” can be produced by the color sensor alone. Since the color sensor has fewer photoreceptors than a conventional sensor, it will produce less total heat and use less total power.

There is another potential advantage of a dual sensor camera in the area of contrast focusing. If there is a mechanism that can move one sensor out of the focal plane briefly, that sensor could supply differential contrast information as part of the focusing procedure. If one sensor is moved from the focus plane, then it is likely that the image on one sensor will be more out of focus (have reduced contrast) than another. This differential information can indicate the direction and even the amount of focusing movement that is required from the lens. The result is faster focusing.

Some of today's cameras have the ability to compensate for movement of the camera: (primarily due to being held by a person) during an exposure. A mechanism senses the movement of the camera and compensates by moving the sensor in the opposite direction. In order to use this system with the dual sensor camera it will be necessary to move both sensors simultaneously. Fortunately, the movements are precisely matched. Therefore, only one correction sensing mechanism is required. The side-to-side movements are precisely the same. This can be accomplished by mechanically linking the two sensors or by using independent actuators that are given matching signals. The upward and downward movements of the vertical sensor must be matched to outward and inward movements, respectively, of the horizontal sensor. Again, this can be accomplished with mechanical linkage or independent actuators.

A dual sensor camera could use a single shutter, if that shutter is placed before the mirror. Another option is to use separate shutters on each sensor. The shutters could be made to respond to the same triggering signals. In some extreme cases, such as very high-speed action with a very short exposure, there might be difficulties synchronizing the two shutters. However, this problem is no less daunting that the difficultly with the single sensor solution, since the moving slit shutter also has problems in this area.

The invention claimed is:

1. A method of capturing still and video images in a digital camera wherein the single color-filtered image sensor (referred to here as the original sensor) commonly found in such cameras is replaced by the combination of a different color-filtered image sensor of equal or nearly equal size, a panchromatic image sensor of equal or nearly equal size, and a means of sharing the light delivered by the camera's lens system between the two image sensors, and where the configurations of the replacement color-filtered image sensor, the panchromatic image sensor, and the dividing mechanism is such that:
the area of each photo-site on the replacement color-filtered image sensor is increased so that the amount of light reaching each photo-site is not less than the light that reached each photo-site of the original sensor despite the loss of light that results from sharing light with the panchromatic sensor;
the area of each photo-site on the panchromatic sensor is less than or equal to the area of each photo-site on the original sensor; and
the proportion of light delivered to the panchromatic sensor is such that that the amount of light recorded by its photoreceptors is no less than half of the amount of light that was recorded by the photoreceptors of the original sensor, taking into account the fact that the panchromatic sensor's photoreceptors will record more light, in general, than will a color-filtered sensor's photoreceptors of equal size under the same lighting conditions.

2. The method as defined by claim 1 that includes a process of deriving an image dataset from each sensor that conforms to a format that is common to both sensors and a process of combining these two image datasets that will take into account the physical properties of the photoreceptors on each sensor, such as the amount of electrical charge each can hold, and where the combining process may allocate weights for the contribution from each element in each dataset, designed so as to produce the best image quality according to some metric, which will include, but not be limited to, considerations of noise, dynamic range, resolution, and visual perception.

3. The method as defined in claim 1 in which the replaced color-filtered image sensor is theoretical in nature, never having existed, and only serving as a mathematic device useful in the design of a digital camera using the method described in claim 1, or where such a theoretical color-filtered image sensor could exist.

4. The method as defined in claim 1 where the original color-filtered image sensor, the replacement color-filtered image sensor, or both are sensors capable of recording color information but are not describable by the term “color-filtered.”
